(19) United States
(12) Patent Application Publication
(10) Pub. No.: US 2006/0238799 A1
(43) Pub. Date: Oct. 26, 2006

(54) Apparatus and method for selecting a printer for printing a document

(75) Inventor: Kazuaki Kidokoro, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/111,841

(22) Filed: Apr. 22, 2005

(51) Int. Cl. G06F 3/12

(52) U.S. Cl. 358/1.15; 358/1.1

(57) ABSTRACT

An apparatus and method for selecting a hardcopy device from a plurality of hardcopy devices to print a document includes receiving a request to print a document, and determining printer selection criteria based on attribute information associated with the document. A hardcopy device capable of performing the print request based on the printer selection criteria is automatically identified from the plurality of hardcopy devices, and the document is sent to the identified hardcopy device to be printed.

### FIELD OF THE INVENTION

The present invention relates generally to network printing and, more particularly, to a system and method for selecting a printer for printing a document.

### BACKGROUND OF THE INVENTION

With the spread of networks and high-performance personal computers (PCs) and workstations, it has become more common to maintain documents electronically in place of hardcopy paper versions. In some respects, however, the handling of electronic documents can be more complicated than paper versions. For example, when a document is distributed electronically, the users receiving the document will often print the document, creating a hardcopy version to review the document or to store. The printing of the document can be performed at one of a number of printers connected to the network, each printer having a particular output capability and print cost. Having a multitude of printers with different capabilities and costs connected to the network allows for effective sharing and utilization of the printers and provides each user with several printing options.

When preparing a print job, a user typically selects the printer to print the print job from a list of printers existing in the network. If the print job requires certain particular settings or options, then the user is required to know the capability of each printer before designating which printer to print the print job. In a large network environment, however, it is difficult for each user to know the varying capabilities of each of the networked printers.

In a conventional system, it has been known to preset the printing options for a particular printer. When a user wants to start a print job, the user can select from one of the preset printing options of a particular printer and submit the print job to that printer using the preset printing options. In this conventional system, the user must still know the capabilities of each network printer to be able to preset the printing options for any of the printers.

In another conventional system, information about paper size, font types, resolution and location is retrieved from each network printer. The retrieved information is obtained from a storage area of each printer. A user specifies a printing requirement according to one or more of paper size, font type, resolution, and locations. The retrieved information from each network printer is compared to the user-specified printing requirement to determine a list of printers, which is presented to the user, that can perform the user-specified printing requirement. The user then selects the printer to print the print job from among the listed printers.

### SUMMARY OF THE INVENTION

According to an aspect of the invention, an image forming apparatus and method for selecting a hardcopy device from a plurality of hardcopy devices to print a document includes receiving a request to print a document, and determining printer selection criteria based on attribute information associated with the document. A hardcopy device capable of performing the print request based on the printer selection criteria is automatically identified from the plurality of hardcopy devices, and the document is sent to the identified hardcopy device to be printed.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a block diagram of a network consistent with the present invention.

FIG. 2 is a block diagram of a print selection system consistent with the present invention.

FIG. 3 is an example of a hardcopy device capability table consistent with the present invention.

FIG. 4 is an example of a judgment rule table consistent with the present invention.

FIG. 5 is a flow chart of a print selection process consistent with the present invention.

### DETAILED DESCRIPTION OF PREFERRED EMBODIMENT

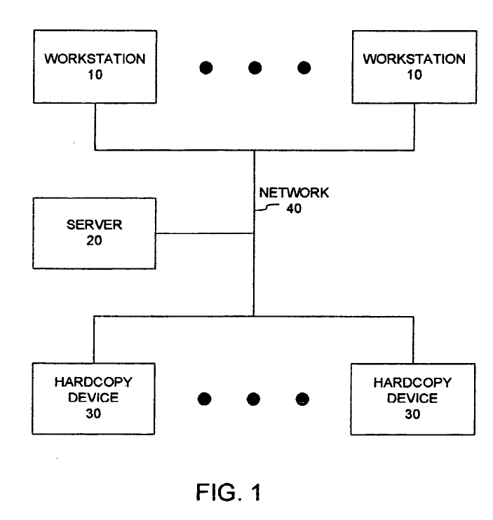

FIG. 1 is a block diagram of a network consistent with the present invention. As shown in FIG. 1, the network includes a plurality of workstations 10, a server 20, a plurality of hardcopy devices 30 and a network 40. Each of the workstations 10, the server 20 and each of the hardcopy devices 30 are coupled to the network 40. The network 20 may be implemented as a local network, such as a LAN, or as a public network, such as the Internet. Although only a pair of workstations 10 and three hardcopy devices 30 are shown, it should be understood that the image processing system may include any number of workstations 10 and hardcopy devices 30.

The workstation 10, which may be a PC or a server, includes a CPU, a main memory, a ROM, a storage device and a communication interface all coupled together via a bus in one embodiment consistent with the present invention. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface for the workstation 10 provides a two-way data communication coupling via a network link to the network 40. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the network 40.

If the network 40 is implemented as the Internet, the workstation 10 can transmit a requested code for an application program through the Internet, an ISP, the local network and the communication interface. The received code can be executed by the CPU in the workstation or server as it is received, stored in the storage device, or stored in some other non-volatile storage for later execution. In this manner, a user at the workstation or server may obtain application code in the form of a carrier wave. The server 20 may be implemented in the same manner as the workstation 10, plus any other functionality that may be needed to manage the operation of the network 40.

In operation, the workstations 10 communicate with the hardcopy devices 30 via the network 40, or via a more direction connection, such as by USB. This communication enables the workstation 10 to request the hardcopy device 30 to perform a function, such as to print a document or to send or receive a fax. In addition, the workstation 10 can request information from the hardcopy device 30.

The hardcopy device 30 is a device which can generate a reproduction of an electronic document, such as a printer, a multi-function peripheral (MFP), or any other device capable of generating hardcopies of documents or files. For the purposes of the following description, it is assumed that at least two of the hardcopy devices 30 have different capabilities. For example, one hardcopy device 30 may be color capable, have a high resolution, have a low page per minute, and provide multiple finishing options, such as stapling or hole-punching, while another hardcopy device 30 may be monochrome (i.e., black and white or B/W), have a low resolution, have a high page per minute, and not provide any finishing options.

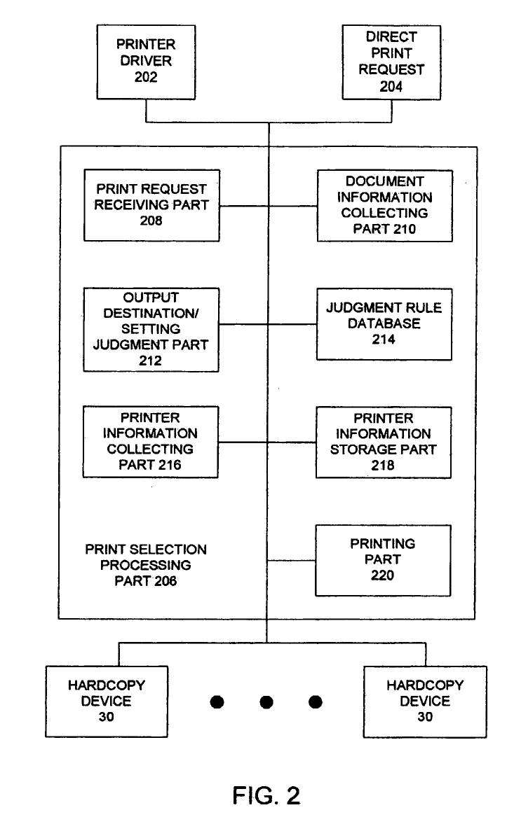

FIG. 2 is a block diagram of a print selection system consistent with the present invention. As shown in FIG. 2, the print selection system includes a printer driver 202, a direct print request 204, and a print selection processing part 206. The print selection processing part 206 includes a print request receiving part 208, a document information collecting part 210, an output destination/setting judgment part 212, a judgment rule database 214, a printer information collecting part 216, a printer information storage part 218, and a printing part 220. Also shown in FIG. 2 is a series of hardcopy devices 30. Each of the components of the print selection system can be implemented in hardware, in software, or in some combination thereof. Further, the components can be implemented in one device, such as the workstation 10 or the server 20, or distributed among multiple devices, such as having the printer driver 202 and direct print request 204 in the workstation 10 and having the print selection processing part 206 in the server 20. In general, the print selection processing part 206 can be implemented on each workstation 10 in the network 40, on the server 20, or some combination thereof.

The printer driver 202 can be activated in response to a print request from an application, such as a word processing or image processing application, operating on the workstation 10 or the server 20. The printer driver 202 is preferably configured to generate a print job based on the print request and the document or file that is the subject of the print request. To generate the print request, a user of the application may request that a document be printed from a pull-down menu or by a shortcut keystroke. The print request may also include a number of settings or parameters for the print, such as color or B/W, page size, finishing parameter, etc.

The direct print request 204, like the printer driver 202, can be activated by a print request and configured to generate a print job in response to the print request and the applicable document of file to be printed. In the direct print request 204, however, an unopened document or file is printed directly without opening or editing the document. For example, a document or file listed in a file manager or document management system, or attached in an e-mail, can be selected and printed with the direct print request 204 without first opening it.

The print selection processing part 206 is configured to identify or select an appropriate hardcopy device 30 in the network 40 to print a document or file in response to a print job received from the printer driver 202 or the direct print request 204. To make the appropriate selection, the print selection processing part 206 includes the print request receiving part 208, which receives the print job from the printer driver 202 or the direct print request 204. The receipt of a print job by the print request receiving part 208 activates the other components of the print selection processing part 206.

In accordance with the print request receiving part 208 receiving the print job, the document information collecting part 210 is configured to collect information about the document to be printed including attribute information for the document. The attribute information for the document corresponds to features or characteristics of the document itself and is distinct from any settings made in the print request and set forth in the print job. Such attribute information of a document includes, for example, the existence of color pages, the resolution of images in the document, signature information (e.g., draft, final, signature, approved), the maximum paper size, security or accessibility setting (e.g., public document, read only, accessible only limited to group or individual), the location or type of document (e.g., e-mail, local storage, database, the Web), the document data type (e.g., photos, images, text), or any other information regarding a characteristic of the document itself.

The output destination/setting judgment part 212 is configured to use the attribute information collected by the document information collecting part 210 to determine printer selection criteria and printer settings, and to select a hardcopy device 30 that is most suitable for processing the print job. The printer selection criteria corresponds to capabilities needed by a hardcopy device 30 to complete the print job. The printer settings correspond to formatting or finishing settings to be used to complete the print job. To select the hardcopy device 30, the output destination/setting judgment part 212 refers to rules stored in the judgment rule database 214. The rules are applied to the attribute information of the document being printed. Based on the application of the rules, one or more hardcopy devices 30 is identified as being appropriate for processing the print job.

The printer information collecting part 216 is configured to collect information regarding the capabilities of each hardcopy device 30 in the network 40. The capability information collected by the printer information collecting part 216 is stored in the printer information storage part 218, which stores the capability information of each hardcopy device 30 in the network 40. In addition, the printer information storage part 218 preferably includes information indicating whether the capability information of a hardcopy device 30 is up-to-date. To ensure that the capability information is up-to-date, the printer information collecting part 216 can be configured to collect the capability information any time capability of a hardcopy device 30 changes.

The capability information of each hardcopy device 30 includes, for example, color capability, resolution, paper sizes available, finishing capabilities (e.g., stapling, hole-punch), paper quality, duplex capability, cost per printed page, or any other information identifying a characteristic or capability of the hardcopy device 30. The capability information collected by the printer information collecting part 216 is used by the output destination/setting judgment part 212, in conjunction with the attribute information of the document being printed and the rules stored in the judgment rule database 214, to determine the appropriate hardcopy device 30 for printing the document.

The printing part 220 is configured to forward the print job to the appropriate hardcopy device 30 selected by the output destination/setting judgment part 212. The print job is transferred from the printing part 220 over the network 40 and received by the selected hardcopy device 30, which prints the document in accordance with the settings of the print job. Such printing can occur automatically, or the user can be provided the option to confirm the print job and associated chosen hardcopy device before the printing actually occurs.

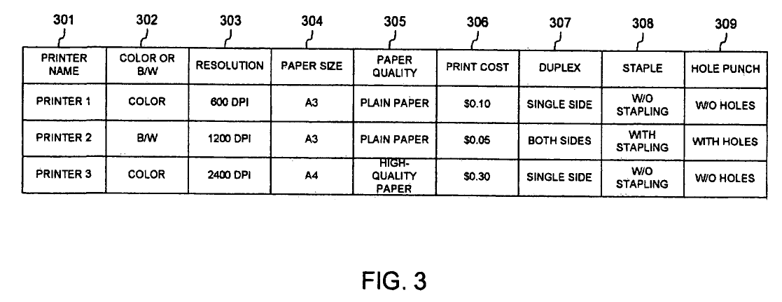

FIG. 3 is an example of a hardcopy device capability table consistent with the present invention. As shown in FIG. 3, the capability table includes nine data items: printer name 301, color or B/W 302, resolution 303, paper size 304, paper quality 305, print cost 306, duplex 307, staple 308, and hole punch 309. Although there are nine items shown, it should be understood that the table may include fewer or additional items related to any other capability or characteristic of a hardcopy device 30.

The printer name 301 corresponds to a unique identifier of each hardcopy device 30 in the network 40. The color or B/W 302 indicates whether the hardcopy device 30 is capable of producing color printouts. The resolution 303 indicates the resolution in dots per inch (DPI) of the hardcopy device 30. The higher the number for the resolution 303, the better the resolution. The actual number listed typically corresponds to the highest resolution possible. The hardcopy device 30 may be capable of generating printouts having lower resolutions than the one indicated by the resolution 303, which may enable the hardcopy device 30 to print pages at a higher rate.

The paper size 304 corresponds to the largest paper size that can be produced by the hardcopy device 30. The paper size 304 may be further configured to identify each of the paper sizes available for printing by the hardcopy device 30, and not just the largest paper size available. The paper quality 305 corresponds to the type or quality of the paper used by the hardcopy device 30. Like the paper size 304, the paper quality 305 may be configured to identify each paper quality type available to the hardcopy device 30. The print cost 306 corresponds to a cost per page printed by the hardcopy device 30. Although shown with a fixed cost per page, the print cost 306 may be variable depending upon the paper quality 305, the paper size 304, the resolution 303, and the color or B/W 302 used for the print. For example, a B/W print at a low resolution using low quality paper may be less expensive than a color print at a high resolution using high quality paper.

The duplex 307 indicates whether the hardcopy device 30 is capable of producing printouts with printing on both sides of each paper sheet. The staple 308 indicates whether the hardcopy device 30 is capable of stapling together sheets of a printout. Similarly, the hole punch 309 indicates whether the hardcopy device 30 is capable of making a hole punch to sheets of a printout. The staple 308 and the hole punch 309 are examples of possible finishing parameters for a print job.

The information in the capability table of FIG. 3 is used by the output destination/setting judgment part 212 to determine which of the hardcopy devices 30 is capable of performing the print job. For example, if the print job calls for a B/W print with duplex printing on A3 paper, then according to the capability table of FIG. 3 it is possible for printer 2 to perform the print job. The capability table can be stored, for example, in the printer information storage part 218.

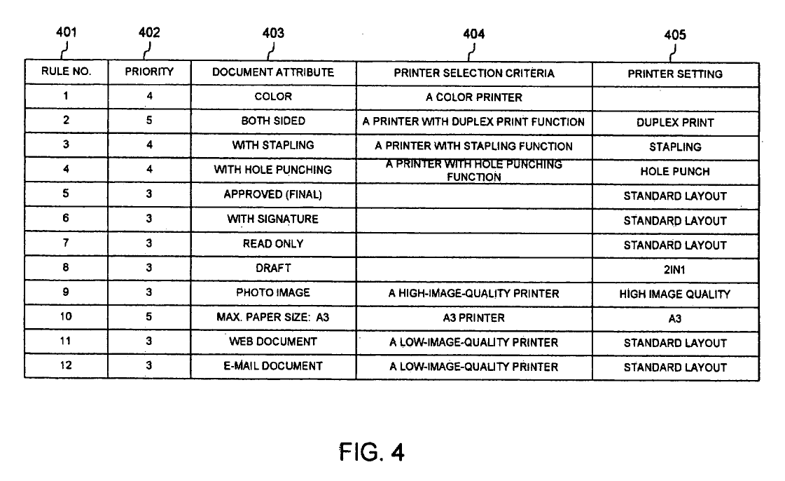

As described above, the output destination/setting judgment part 212 not only uses the capability information of the hardcopy devices 30 to select the appropriate hardcopy device 30 for performing the print job, it also references the attribute information of the document being printed and applies judgment rules to determine printer selection criteria and printer settings, which are used to make the selection. FIG. 4 is an example of a judgment rule table consistent with the present invention. As shown in FIG. 4, judgment rule table includes five data items: rule number 401, priority 402, document attribute 403, printer selection criteria 404, and printer setting 405.

The rule number 401 is a unique identifier for each rule in the judgment rule database. The priority 402 indicates a value or importance of a particular rule relative to other rules in the judgment rule database. As shown in FIG. 4, each rule has a value between 1 and 5, with 5 being the most valuable. For example, rule number 2 has a priority of 5, while rule number 1 has a priority of 4. Accordingly, rule number 2 has a higher priority than rule number 1. In the event that rule number 1 and rule number 2 are both applicable to a print job, and no hardcopy device 30 is capable of completing the print job in accordance with both rule number 1 and rule number 2, then rule number 2 would be given priority over rule number 1, and a hardcopy device 30 would be selected that can complete the print job in accordance with rule number 2.

The document attribute 403 corresponds to a particular attribute from the attribute information of the document being printed. As shown in FIG. 4, the document attributes 403 included in the judgment rule table include color, both sided (i.e., duplex), with stapling, with hole punching, approved (final), with signature, read only, draft, photo image, maximum paper size: A3, web document, and e-mail document. It should be understood that additional rules in accordance with a particular attribute of the document may also be included in the judgment rule table. The ones listed for document attributes 403 are merely exemplary. Based on the attribute information of the document, the output destination/setting judgment part 212 determines which rules of the judgment rule table to apply. For example, if the document that is the subject of the print job is a draft version of a color document, then rule number 1 and rule number 8 would apply.

The printer selection criteria 404 identify capabilities or characteristics needed by a hardcopy device 30 to perform the print job if the corresponding rule applies. As shown in FIG. 4, the printer selection criteria 404 include a color printer, a printer with duplex print function, a printer with stapling function, a printer with hole punching function, a high-image-quality printer, an A3 printer, and a low-image-quality printer. It should be understood that other printer selection criteria 404 in accordance with a particular attribute of the document may also be included in the judgment rule table, and the ones listed are merely exemplary. The printer selection criteria 404 are related to the corresponding document attribute 403. For example, if the document attribute 403 is both sided, then the corresponding printer selection criterium 404 is that the hardcopy device 30 has a duplex print function.

Finally, the printer setting 405 is a setting or parameter set in the print job to effectuate the performance of a particular function of the hardcopy device. As shown in FIG. 4, the printer setting 405 includes duplex print, stapling, hole punch, standard layout, 2in1, high image quality, and A3. It should be understood that other printer settings 405 in accordance with a particular attribute of the document may also be included in the judgment rule table, and the ones listed are merely exemplary. For example, the printer setting 405 may also include a paper type, such as high quality or low quality paper.

The printer setting 405 corresponding to a particular rule may be a setting already included in the print job or one that is added to the print job in accordance with a corresponding document attribute 403. For example, if the document being printed is a draft document, the printer setting 405 is 2in1, which is two page images per page, in contrast to the standard layout of one page image per page. The 2in1 printer setting 405 is used because the document is a draft document not for distribution, and the 2in1 printer setting 405 reduces the number of paper sheets need to print the document. Accordingly, if the document being printed is a draft document, the 2in1 printer setting can be added to the print job to reduce the number of paper sheets used to print the document.

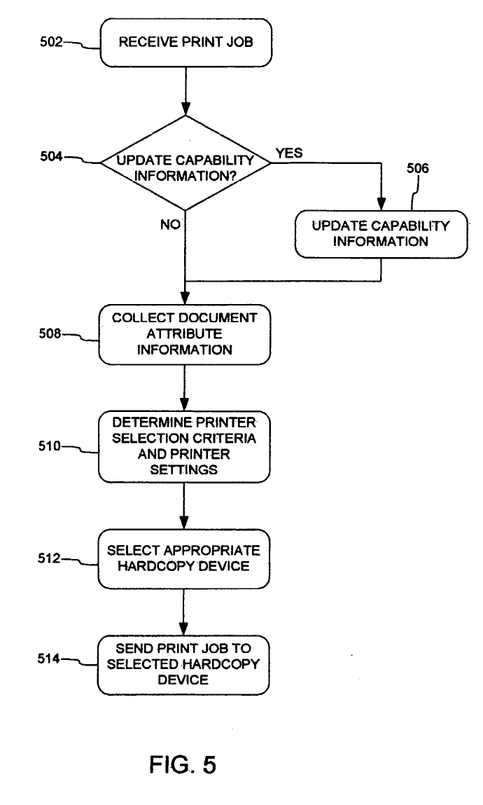

FIG. 5 is a flow chart of a print selection process consistent with the present invention. As shown in FIG. 5, first a print job is received (step 502). As described above, a user can make a print request via the printer driver 202 or the direct print request 204. The print request identifies the document to be printed. The printer driver 202 and the direct print request 204 generate a print job in accordance with the print request and the identified document. The print job is received by the print request receiving part 208 of the print selection processing part 206.

A check is made to determine whether to update the capability information of the hardcopy devices (step 504). The capability information identifies capabilities of each hardcopy device 30 in the network 40. The capability information is collected by the printer information collecting part 216 and is stored in the printer information storage part 218. As described above, the capability information of each hardcopy device 30 includes, for example, color capability, resolution, paper sizes available, finishing capabilities (e.g., stapling, hole-punch), paper quality, duplex capability, cost per printed page, or any other information identifying a characteristic or capability of the hardcopy device 30. The storage of the capability information in the printer information storage part can be in the form of a table, such as shown in FIG. 3.

To determine whether to update the capability information, a check is made to determine whether the capability information for any of the hardcopy devices 30 has changed. For example, the available paper type or paper size at the hardcopy device may have changed. Alternatively, the determination of whether to update the capability information may be made if a predetermined amount of time has passed since the last update was made. If the determination is yes, then the capability information is updated (step 506). The updating of the capability information can be performed for each of the hardcopy devices 30 in the network 40. Alternatively, the updating can be performed only for the hardcopy device 30 whose capability information has changed.

In response to receiving the print job, the document information collecting part 210 collects the attribute information for the document that is the subject of the print job (step 508). As described above, the attribute information for the document includes, for example, the existence of color pages, the resolution of images in the document, signature information (e.g., draft, final, signature, approved), the maximum paper size, security or accessibility setting (e.g., public document, read only, accessible only limited to group or individual), the location of the document (e.g., e-mail, local storage, database, the Web), the document type (e.g., photos, images, text), or any other information regarding a characteristic of the document.

In accordance with the attribute information of the document being printed, the output destination/setting judgment part 212 determines the printer selection criteria and the printer settings (step 510). The printer selection criteria correspond to capabilities needed by a hardcopy device 30 to complete the print job. The printer settings correspond to formatting or finishing settings to be used to complete the print job. To determine the printer selection criteria and the printer settings, the output destination/setting judgment part 212 references judgment rules stored in the judgment rule database 214. More specifically, the output destination/setting judgment part 212 identifies rules in the judgment rule database 214 corresponding to the attribute information of the document being printed. As shown in FIG. 4, each judgment rule has a distinct document attribute 403. In addition, for each document attribute 403, there is a corresponding printer selection criterium 404 and/or a corresponding printer setting 405. Accordingly, the printer selection criteria includes the printer selection criteria 404 corresponding to each document attribute 403 of the document attribute information, and the printer settings includes the printer settings 405 corresponding to each document attribute 403.

In addition to determining the printer selection criteria and the printer settings, the output destination/setting judgment part 212 selects an appropriate printer to perform the print job (step 512). To make the selection, the output destination/setting judgment part 212 references the capability information stored in the printer information storage part 218 and determines which, if any, of the hardcopy devices 30 satisfy the printer selection criteria. In other words, the output destination/setting judgment part 212 determines the hardcopy device having each of the capabilities set forth in the printer selection criteria. For example, with reference to FIG. 4, if document attributes 403 of the document being printed indicate the document is a double-sided, web document to be stapled, then the corresponding printer selection criteria would be for a printer having a duplex print function, a stapling capability, and having a low image quality. As shown in FIG. 3, printer 2 satisfies each of these criteria.

However, if none of the hardcopy devices 30 are able to satisfy the printer selection criteria, then a modification is made to the printer selection criteria. To make this modification, reference is made to the priority 402 corresponding to each judgment rule. For example, if the document attributes 403 of the document being printed indicate that it is a color, double-sided document, then the printer selection criteria would be for a color printer having a duplex print function. As shown in FIG. 3, none of the three hardcopy devices 30 listed have both a color capability and a duplex print function. As shown in FIG. 4, the judgment rule 2 for the double sided document attribute 403 has a priority of 5, while judgment rule 1 for the color document attribute 403 has a priority of 4. Since judgment rule 2 has a higher priority, it takes precedent over judgment rule 1, and a hardcopy device 30 is identified having the duplex print function. In this case, as shown in FIG. 3, printer 2 is again selected. Any set of rules, and combinations of attributes, can be used to determine which hardcopy device 30 to select.

Furthermore, if more than one hardcopy device 30 satisfies the printer selection criteria, then additional criteria can be used to identify an appropriate hardcopy device 30 to perform the print. The additional or deciding criteria may include, for example, a location of the hardcopy device 30 or a print cost for the hardcopy device 30. If two hardcopy devices 30 satisfy the printer selection criteria, then the one chosen to perform the print can be the one closest to the location of the user generating the print job or the one having the lowest print cost. It is also possible to configure the output destination/setting judgment part 212 to display to the user a list of hardcopy devices 30 that satisfy the printer selection criteria and allow the user to select the hardcopy device 30 to perform the print from the list.

The printing part 220 sends the print job to the hardcopy device 30 selected by the output destination/setting judgment part 212 (step 514). The print job sent to the hardcopy device 30 includes not only the information received by the print request receiving part, but also the printer settings determined by the output destination/setting judgment part 212. For example, if the document attribute 403 is draft, then the printer setting 405 is for a 2in1 layout. The print job received by the hardcopy device 30 would therefore include a setting that the document be printed with a 2in1 layout. In the event that the printer is chosen by a user from a list of hardcopy devices 30 that satisfy the printer selection criteria, then the printing part 220 sends the print job to the hardcopy device 30 selected by the user.

In accordance with present invention, it is possible to make a print request without the user having to select the hardcopy device to print the document. Further, by referencing the attribute information of the document being printed, it is possible to identify applicable printer selection criteria and printer settings in accordance with various judgment rules. The printer selection criteria is used to select an appropriate hardcopy device for printing the document. As a result, a user may request a document be printed without knowing the printing capabilities of each networked hardcopy device when making the request.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for selecting a hardcopy device from a plurality of hardcopy devices to print a document, comprising:
receiving a request to print a document;
determining printer selection criteria based on attribute information associated with the document;
automatically identifying a hardcopy device from the plurality of hardcopy devices capable of performing the print request based on the printer selection criteria; and
sending the document to the identified hardcopy device to be printed.

2. A method according to claim 1, wherein the attribute information of the document includes at least one of color, image type, or resolution.

3. A method according to claim 2, wherein the attribute information further comprises at least one of stapling or hole punching, and the corresponding printer selection criteria is a hardcopy device capable of performing stapling or hole punching, respectively.

4. A method according to claim 1, wherein the request to print the document includes one or more print settings, the method further comprising:
determining an additional print setting based on the attribute information of the document; and
modifying the request to print the document to include the additional print setting.

5. A method according to claim 4, wherein the attribute information of the document indicates that the document is double sided, and
wherein the additional print setting is a duplex print setting.

6. A method according to claim 4, wherein the attribute information of the document indicates a status of the document; and
wherein the additional print setting is either a standard layout or an N:1 layout in accordance with the status of the document, N being an integer greater than 1.

7. A method according to claim 6, wherein the additional print setting is a standard layout if the status is either approved or final, and the additional print setting is a N:1 layout if the status is draft.

8. A method according to claim 4, wherein the attribute information of the document indicates a status of the document; and
wherein the additional print setting is either a high quality paper or a low quality paper in accordance with the status of the document.

9. A method according to claim 8, wherein the additional print setting is a high quality paper if the status of the document is either approved or final and the additional print setting is low quality paper if the status of the document is draft.

10. A method according to claim 1, wherein the determining step includes:
identifying one or more judgment rules in accordance with the attribute information of the document; and
determining the printer selection criteria based on the identified judgment rules.

11. A method according to claim 10 further comprising:
associating a priority with each of the judgment rules; and
if none of the plurality of hardcopy devices is capable of performing the print request according to the printer selection criteria, then altering the printer selection criteria based on the priority of the identified judgment rules.

12. A method according to claim 11, wherein the step of altering includes not considering the judgment rule with the lowest priority from among the identified judgment rules used to determine the printer selection criteria.

13. A method according to claim 1, wherein the attribute information includes an indication of a document type, and
wherein the printer selection criteria includes a hardcopy device having an image quality in accordance with the document type.

14. A method according to claim 13, wherein the printer selection criteria is for a low image quality hardcopy device if the document type an e-mail or a Web document, and for a high image quality device if the document type is a photographic image.

15. A method according to claim 1, wherein the attribute information includes an indication of a security setting for the document; and
wherein the printer selection criteria includes a hardcopy device security level in accordance with the security setting.

16. A method according to claim 1, further comprising:
collecting print capability information for each of the plurality of hardcopy devices; and
storing the collected print capability information in a memory.

17. A method according to claim 16, wherein the identifying step includes using the print capability information stored in the memory to identify the hardcopy device.

18. A method according to claim 16, further comprising updating the print capability information of at least one of the plurality of hardcopy devices.

19. A method according to claim 18, wherein the print capability information is updated if at least one of a print capability of a hardcopy device is changed or a predetermined period of time has lapsed.

20. A method according to claim 1, wherein the step of identifying includes identifying more than one hardcopy device capable of performing the print request based on the printer selection criteria

21. A method according to claim 20, wherein the step of sending includes sending the print request to one of the more than one identified hardcopy devices in accordance with at least one of a location of the hardcopy device or a print cost for the hardcopy device.

22. A method according to claim 20, further comprising:
displaying a list of the more than one identified hardcopy devices; and
receiving a selection of one of the more than one identified hardcopy devices,
wherein the step of sending including sending the print request to the hardcopy device corresponding to the received selection.

23. A system for selecting a hardcopy device from a plurality of hardcopy devices to print a document, comprising:
a processor; and
a memory, coupled to the processor, the memory comprising a plurality of instructions executed by the processor, the plurality of instructions configured to:
receive a request to print a document;
determine printer selection criteria based on attribute information associated with the document;
automatically identify a hardcopy device from the plurality of hardcopy devices capable of performing the print request based on the printer selection criteria; and
send the document to the identified hardcopy device to be printed.
